(19) United States
(12) Patent Application Publication
(10) Pub. No.: US 2003/0113933 A1
(43) Pub. Date: Jun. 19, 2003

(54) Analysis of components in liquids

(76) Inventors: Rasmus Jansson, Linkoping (SE); Per Lango, Uppsala (SE)

Correspondence Address: JENKENS & GILCHRIST, PC, 1445 ROSS AVENUE, SUITE 3200, DALLAS, TX, 75202, US

(21) Appl. No.: 10/025,564

(22) Filed: Dec. 18, 2001

(51) Int. Cl. G01N 27/00

(52) U.S. Cl. 436/150; 436/149; 436/73; 436/80; 436/84; 422/82.01; 422/82.02

(57) ABSTRACT

The invention comprises in its broadest embodiment analysis of components in liquids by bringing a liquid, containing analyte of interest, in contact with an electronic tongue comprising at least one electrode of a material selected from the group consisting of the groups 6-12 of the periodic table, preferably groups 9-11, or alloys thereof. Preferably the metal is selected from the platinum group metals, the most preferred material being Pt. A voltage pulse sequence is applied to the electrodes. The pulse amplitudes can be different for different electrodes, and suitably the amplitudes are varied between negative potentials and positive potentials.

### FIELD OF THE INVENTION

The present invention relates generally to the analysis of components in liquids by voltammetric methods, and in particular to the monitoring of a dialysis procedure by analysis of indicator components in dialysis liquids.

### BACKGROUND OF THE INVENTION

Dialysis is nowadays a well established method of treating patients suffering from kidney insufficiency for various reasons. Furthermore, the number of patients requiring dialysis are believed to increase over the coming years. Dialysis is a way to partially replace the kidney function. Thereby the blood is purified or cleaned by using a special purification liquid, a solution referred to as a dialyzate, and a filter. The filter can be the tissues within the body (peritoneal dialysis), or an artificial kidney (heamodialysis).

Thus, the main function of dialysis is to remove toxic waste products produced by the body, from people suffering from impaired renal function. One such waste product is urea, which is the end product of protein metabolism. Urea clearance is often used as an indicator of how well the dialysis treatment is working, that is how well the blood is purified. An important aspect of dialysis treatment is to ascertain when a sufficient level of urea removal has been achieved, i.e. when the treatment procedure can be stopped without jeopardizing the patient's health.

Current procedures of ascertaining such a treatment are based on blood sampling and analysis of the blood after the treatment. Clinics often rely on monthly lab work to determine if changes are required in a prescribed treatment regime. This means that an insufficient dialysis treatment may be detected quite late, often between 10 and 15 treatment occasions after the last lab results were obtained. Thus, the duration of the dialysis procedure is determined by the physician and is based on experience and obsolete laboratory results from previous treatments rather than on-line measurements of the individual process.

This is of course unsatisfactory from a medical point of view, in that very many patients, if not to say the most, probably do not obtain optimal treatment. It would therefore be desirable to have access to an on-line (or in-line) real-time measurement of blood components such that the actual concentration of e.g. urea could be measured instantaneously. By designing methods to monitor the blood purification process in real time, there are great potential benefits for both personnel and patients. Thereby the person operating the dialysis equipment would be able to stop the treatment exactly at the right moment, when the urea concentration reaches a desired level. Such a system could also be potentially very powerful for home dialysis in the future.

An attempt to solve this problem has been made by Fresenius Medical Care by their on-line clearance function. However, this system is very hard to operate and requires a fairly high level of operating skill, meaning that it requires specially trained personnel, which in view of the expected increasing number of treatments most likely would increase the cost for treatment to an unacceptable level, that would simply not be compatible with current health insurance systems.

In-line measurement of e.g. blood components, i.e. continuously measuring analytes in the blood path is a potentially efficient method. However, the risks associated with the introduction of measuring probes in the blood path are potentially large, in that no such measurement method leaves the blood unaffected.

In view of the above discussion, it is to be understood that simplicity of a real-time/on-line system is a requirement for it to be feasible in practice.

### SUMMARY OF THE INVENTION

Thus, the object of the present invention is to provide a real-time, on-line system (in view of the potential hazards, in-line methods are not the subject of the present invention) for the direct or indirect monitoring of components in liquids, in particular blood, in dialyzate or in any combination thereof, by voltammetric analysis using a so-called electronic tongue. In particular it should provide means for monitoring the efficiency of dialysis in a dialysis apparatus, as a stand-alone unit or integrated in a peritoneal dialysis process, by continuously monitoring the level of indicator components in said liquid, thereby enabling control of the level of e.g. urea in blood.

This object is achieved with a method of monitoring a physiological condition of a patient by measuring at least one indicator component concentration in a liquid, comprising: providing a liquid containing at least one indicator component, the concentration of which in said liquid being indicative of said physiological condition; bringing said liquid into contact with a voltammetric electronic tongue, having at least one working electrode consisting essentially of a metal or alloy selected from members of any of the groups 6-12 of the periodic table, preferably groups 9-11; applying a predefined potential pulse program to said at least one working electrode and a counter electrode; recording current response data caused by said potential pulse program; performing a mathematical analysis of recorded current response data according to a model based on multivariate analysis to provide a result.

Thus, the method comprises in its broadest embodiment bringing a liquid, containing analyte of interest, in contact with an electronic tongue comprising at least one electrode of a material selected from the group consisting of the groups 6-12 of the periodic table (i.e. transition metals), preferably groups 9-11, or alloys thereof. Preferably the metal is selected from the platinum group metals, the most preferred material being Pt. A voltage pulse sequence is applied to the electrodes. The pulse amplitudes can be different for different electrodes, and suitably the amplitudes are varied between negative potentials and positive potentials.

The liquid to be analyzed can be blood that is diverted from the vascular system of a patient, and discarded when the analysis is completed. Preferably the liquid to be analyzed is a dialysis liquid that has been used for the purification of blood in a dialysis apparatus, said liquid having passed a filter where the purification takes place. Of course any liquid that contains components (i.e. analytes) that are indicative of a specific condition in a patient can be analyzed, and no liquids are excluded per se. Possible further candidates are urine, intestinal liquids, gastric liquids, lymphatic liquids.

In a dialytic application the method preferably comprises measuring a concentration before and after the filter responsible for the removal of urea from the liquid. The analyte of preference is urea, but a number of other analytes are possible to measure as an indication of dialysis efficiency. Examples of such analytes are (in no order of preference): β2 microkinase, heparin, albumin, cholesterol, PTH (Parathyroid Hormone), glucose, K⁺, Ca²⁺, Creatinine.

The measurement system is based on a voltammetric electronic tongue, the response of which is analyzed by suitable multivariate methods to provide a result in the form of a concentration of the analyte of interest or any other relevant measure, and comprises There is also provided a system for monitoring a physiological condition of a patient by measuring at least one indicator component concentration in a liquid, comprising: a voltammetric sensor unit comprising at least one electrode made of a material selected from any of the groups 6-12 of the periodic table, preferably groups 9-1 1; a counter electrode; a potentiostat having a programmable pulse generator; a processing unit for the mathematical processing of voltammetric data using a model based on multivariate analysis.

### BRIEF DESCRIPTION OF THE DRAWINGS

The invention will be described below with reference to the drawings, in which

FIG. 1 is an example of a SAPV step function;

FIG. 2 is an example of a LAPV step function;

FIG. 3 is an example of a SUPERLAPV step function;

FIG. 4 is a response curve for the SUPERLAPV step function;

FIG. 5 is a schematic view of an electronic tongue;

FIG. 6 is a schematic view of a device with flowing sample liquid;

FIG. 7 is a schematic picture of response patterns of non-selective sensors;

FIG. 8 is an ODP plot for urea measurements with a Pt electrode;

FIG. 9 is an ODP plot of information contribution from an Rh electrode in a urea measurement;

FIG. 10 shows signal energy over time for an electronic tongue;

FIG. 11 is an ODP score plot of stabilization measurements and a normal concentration measurement series;

FIG. 12 is a PLS score plot of validation data;

FIG. 13 is an ODP score plot of the data from FIG. 12;

FIG. 14 is an ODP score plot of training and validation data from different measurement series;

FIG. 15 is a graph showing CRA predictions of the validation data of FIG. 14;

FIG. 16 is a non-calibrated ODP score plot of urea variation I buffer and in dialytic liquid, respectively; and

FIG. 17 is a calibrated version of FIG. 16.

### DETAILED DESCRIPTION OF PREFERRED EMBODIMENTS OF THE INVENTION

For a better understanding of the results presented later, the technological and mathematical foundations of this project, respectively, will be summarized. The inventive method and system is based on the use of a kind of sensor referred to as an electronic tongue, which is based on voltammetry. The non-selectivity of this sensor technology generates large amounts of data which are interpreted using multivariate methods.

The Electronic Tongue

The two most common principles employed for electronic tongues are potentiometry and voltammetry. In potentiometry, the voltage over a charged membrane is measured. In voltammetry, a predefined voltage function—typically a step function with different amplitudes, positive and/or negative—is applied between a catalytically active working electrode and a counter electrode. Optionally a reference electrode can be used. Depending on the electrochemical properties of the conducting medium and the electrode, the voltage causes a specific current response which is measured. The result is a characteristic response profile for the measured medium.

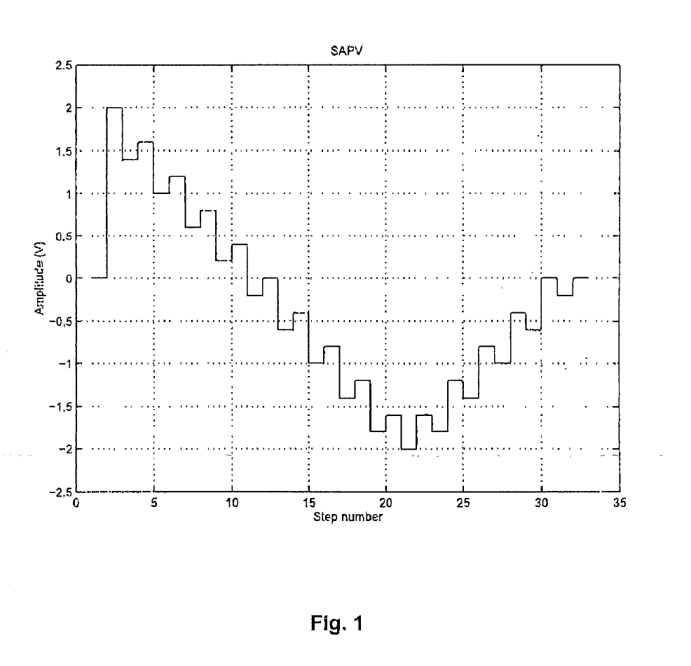

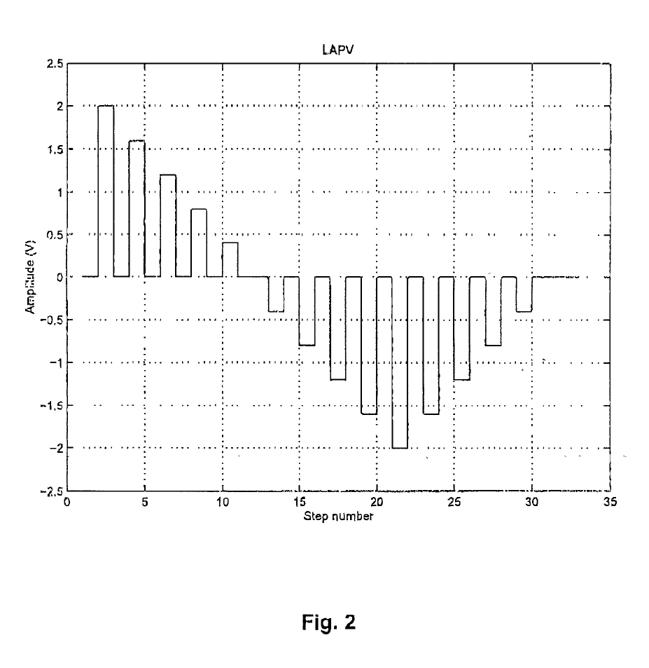

There are many possibilities in selecting voltage functions for the electronic tongue. The most common functions are called SAPV and LAPV, short for small and large amplitude pulse voltammetry. The SAPV step function resembles a staircase, shown in FIG. 1, whereas the characteristic property for a LAPV step function is that the voltage is reduced to zero in between the pulses, shown in FIG. 2.

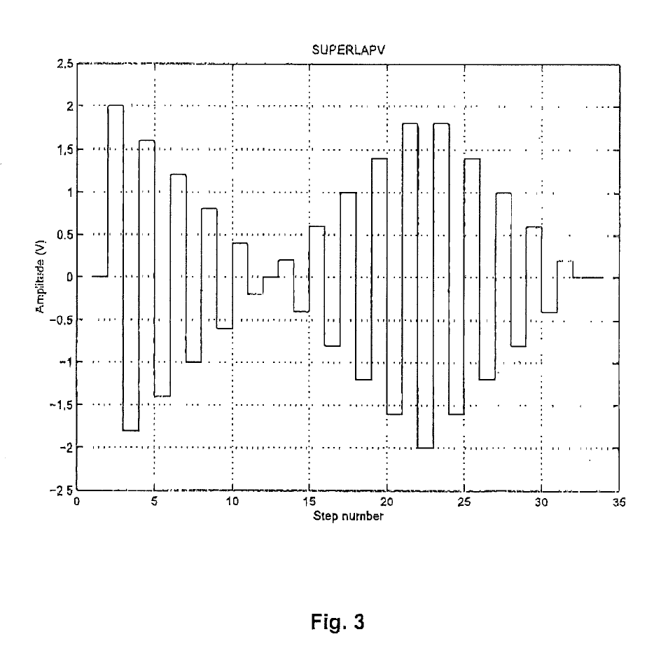

I the present invention we use a voltage function, which will be referred to as the SUPERLAPV, where the voltage oscillates between positive and negative amplitudes. An example of a SUPERLAPV step function is shown in FIG. 3. The three step functions presented here were deliberately made as similar as is possible, to make the actual differences stand out and not be exaggerated by other variations. At a first glance, they appear rather similar because they have the same maximum amplitudes and the same difference between neighboring peak values. However, by virtue of the switching polarity of the SUPERLAPV, it makes possible much larger step-to-step voltage differences than can be obtained with SAPV and twice that of LAPV. As is discussed later, SUPERLAPV was shown to be superior to the other two voltage functions (SAPV and LAPV) for measuring the redox activity of urea, probably because this activity is not as easily triggered by the smaller voltage oscillations of SAPV and LAPV.

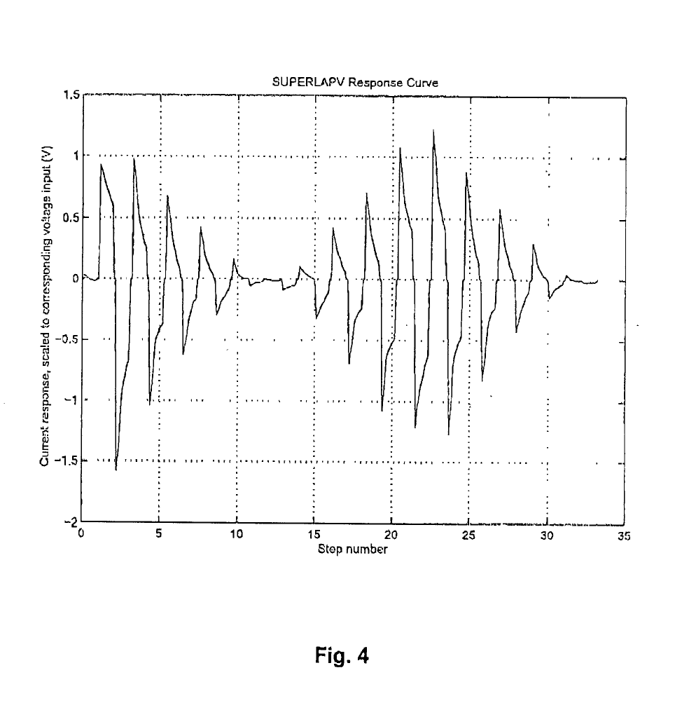

An example of a typical current response is shown in FIG. 4.

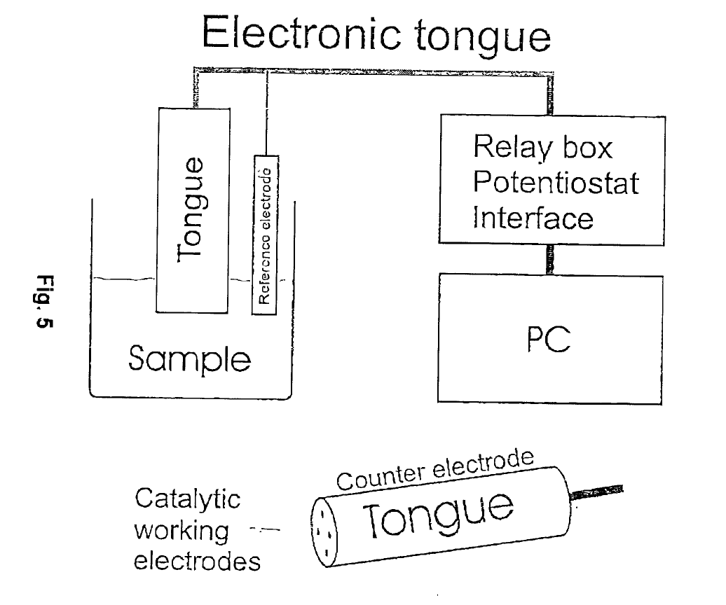

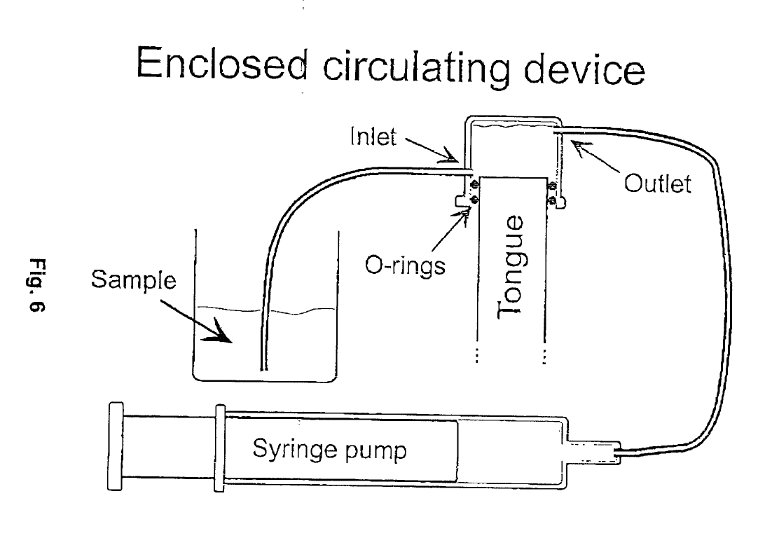

FIG. 5 shows a schematic picture of the electronic tongue and FIG. 6 shows a schematic picture of the device used to control the exchange of samples, and the details of each will be given below. It is to be understood that the shown embodiments, although completely functional for the purpose of demonstrating the invention, are not designed nor optimized for commercial implementation as a final product, and many variations are possible within the inventive concept.

Thus, the illustrated system in the form of an electronic tongue, basically consists of an electrode unit, suitably but not necessarily comprising a plurality of electrodes, in the shown embodiment four electrodes. As shown, the tubular housing in which the four working electrodes are located, in an insulating matrix material, constitutes the counter electrode. The electronic tongue further comprises a potentiostat and a PC (or a suitable microprocessor) for data processing. Thus, the term “electronic tongue”, as used herein, refers rather to the entire system than to the actual sensor unit (i.e. the counter electrode unit).

The sensor unit is immersed in a sample liquid in a suitable vessel, which could be of metal and serve as a counter electrode if the sensor unit is made entirely of an insulating material.

The potentiostat can be conventional and will not be discussed further herein.

In an alternative embodiment, the system comprises a flow cell, in the form of a cap covering the working electrode of the sensor unit, and also exposing the counter electrode (i.e. the housing rim). The sample is introduced into the flow cell via an inlet, e.g. by means of a suitable pump (a syringe pump is illustrated), and is expelled after measurement through an outlet into a waste vessel. Other components are the same as in the embodiment of FIG. 5, but are not shown in FIG. 6.

The liquid to be analyzed can in a preferred embodiment comprise a dialysis liquid. Thereby the sensor unit is arranged in a dialysis liquid flow path after a filter unit of said dialysis apparatus. In a further embodiment the system comprises a further sensor unit, arranged before said filter unit. In this case it may be advantageous to collect samples from the dialysis liquid and perform the measurements on said samples in order to avoid any contamination of the dialysis liquid.

In alternative embodiment the liquid to be analyzed is blood, derived from a patient and said sensor unit is arranged to measure the desired component in a sample of said blood. The blood can thereby be sampled by continuously withdrawing blood from a patient, and said sensor unit is suitably arranged in the diverted flow path of the blood. Since this blood should be collected as waste and disposed of, thereby causing a fairly extensive withdrawal of blood from a patient, it may be advantageous to take samples intermittently and carry out the measurements on such samples for this embodiment.

An ideal, selective sensor is only sensitive to one physical property or chemical compound. This is the preferable sensor type when one wants to measure a specific, pre-defined quality, such as pH, conductivity, or light intensity. Non-selective sensors, on the other hand, respond to more than one stimulus and thus give ambiguous information by themselves. In reality, few sensors are completely selective (reacting to only one stimulus) and none is totally non-selective (reacting to all stimuli). Still, these terms are used to describe sensors with high and low selectivity, respectively.

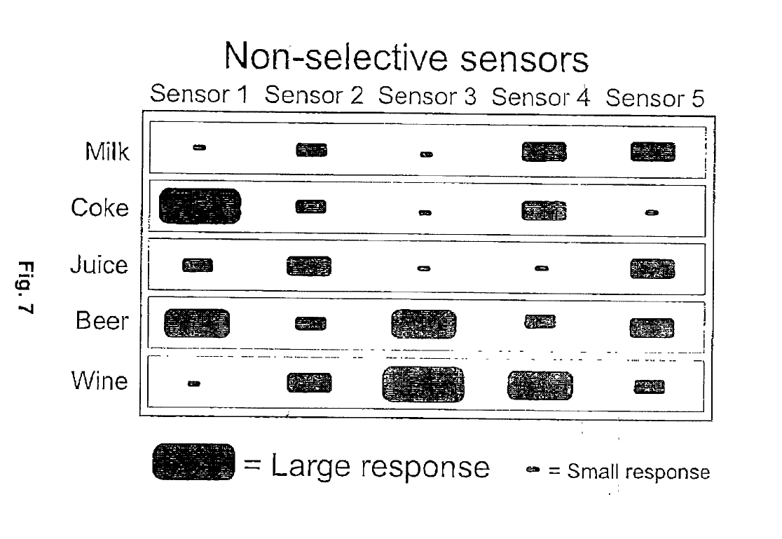

However, by combining the readings of many non-selective sensors, each with different response properties or chemical preferences, a complex pattern or ‘fingerprint’ can be obtained that contains information not measurable by selective sensors. See FIG. 7 for an illustration. Note that in the case of the electronic tongue the word ‘sensor’ as used above is somewhat delusive and refers to each of the numerous sampling points rather than the number of electrodes, although the principle remains the same.

FIG. 7 shows a schematic picture of response patterns from non-selective sensors. By combining several non-selective sensors, a unique ‘fingerprint’ can be obtained for the sample. The picture is not based on real measurements.

Non-selective sensors are particularly useful when the variables of the measurement either are not known beforehand (latent variables) or are difficult to measure directly with existing, selective sensors. The main drawback is that the use of non-selective sensors requires the use of more advanced mathematical tools for data processing.

Multivariate Methods

The data from the electronic tongue was analyzed by multivariate methods, which are an effective means of variable reduction and patterns extraction in large amounts of data. The graphical results (score plots) presented here were obtained by using Principal Component Analysis (PCA), Partial Least Squares (PLS), and Optimal Discriminative Projection (ODP). PCA is only useful for visualizing the result whereas PLS can also be used to build a regression model for quantitative analysis and predictions. Like PLS, ODP can be used both for visualizing the results and for building regression models, but does so in a more sophisticated way.

PCA and PLS

The idea behind PCA and PLS projections is to find the directions, called principal components, in the multidimensional measurement space that contain the largest variance. These directions, typically two to three for clarity, form the plane (or hyperplane) onto which all measurement points are projected. The method is unsupervised, meaning that no information about the measured samples is used to find the latent variable of interest. This causes the method to be intrinsically very sensitive to noise and sensor drift; whenever the drift or noise is significant, it will be represented by one of the first principal components.

ODP

ODP (see Doctoral Thesis by Per Spangéus, “New Algorithms for General Sensors or How to Improve Electronic Noses”, Linköpings Tekniska Högskola, 2001, incorporated herein in its entirety by reference) is a supervised projection method used to find the directions in the multidimensional measurement space that best separate between different classes of samples. Because of this, ODP, unlike PCA and PLS, requires the samples to belong to discrete classes. It is thus a classification algorithm rather than a quantification algorithm. The continuous concentration problem, which is essentially the subject matter in this application, can still be solved by ODP by measuring a sufficiently large number of discrete concentrations, for example 0, 1, 2, . . . , 10 mM, and letting a regression model interpolate between the clusters.

Since class discrimination is a measure not favored by drift and noise, ODP will naturally disregard these directions in the optimized projection. A much simplified description of ODP's optimization is given by the following expression:

$$ODP : {min}_{all directions} \{ \frac{Inclass separation}{Interclass separation} \}$$

Regression Models

By fitting the projected points in the score plots of PLS or ODP to a line or polynomial, one can build a regression model for predicting concentrations. After refinements and optimizations, such a model is what can be implemented in a final sensor product. The regression algorithm for PLS is called PLS regression or PLSR, whereas the regression algorithm that is based on ODP is called CRA, short for Clustered Regression Analysis.

The precision of the regression models, be it based on PLS or ODP, is herein quantified by the same validation measure, (Root Mean Square Error of Prediction; RMSEP), defined as follows (other suitable measures can be applied):

$$RMSEP = \sqrt{\frac{1}{n} {\sum }_{i = 1}^{n} {( {y}_{i , measured} - {y}_{i , predicted} )}^{2}}$$

The definition is analogous to that of standard deviation and may be interpreted in a similar way, only the deviation is calculated as the difference between each measured value and its ‘true’ value instead of the average of the whole set. In this application, a RMSEP of, say, 0.75 mM would mean that the predictions of the regression model are 0.75 mM off the ‘true’ value on average. On a scale from 0 to 10 mM, this RMSEP value corresponds to a relative error of 7.5%. There is no definite maximum level of the relative error that differentiates between a good and a bad model, though a value of less than 10% is often considered acceptable.

The novel and inventive SUPERLAPV step function shown in FIG. 3 has proven superior to the others, SAPV and LAPV respectively, especially for the measurements of urea. This is probably explained by the need of high potential differences to activate the redox activity in urea, which is known to be low. Ordinary SAPV and LAPV step functions do not provide the same large, rapid changes in potential and are hence less suitable for urea measurements.

On a scale from 25 to 700 ms, the most favorable step time was shown to be 25 ms. However, 50 ms was selected for the particular research setup in order to obtain increased hardware stability. For future reference this indicates that there are potential benefits in shortening the step time further, provided there is new hardware to deal with a faster sampling process in a more efficient way. Thus, there is no specific lower limit identified for the step time.

Of the investigated step amplitudes, the largest, ranging from −2 to 2 V, proved most beneficial. This is considered to be a relatively high voltage difference seen from a voltammetric perspective. Still larger amplitudes may work even better, and are not excluded from the invention.

At each measurement, a transient stabilization process was observed. Therefore, each measurement consisted of five cycles (i.e. consecutive measurements on the same sample), of which the first two were disregarded most of the time to decrease the influence of the transient.

The urea molecule is uncharged and does not contribute to the conductivity of the solution. Still, the conductivity of the different samples was measured ‘just in case’ to exclude the possibility of synergistic effects that might affect the conductivity. As expected, the measurements showed no differences in conductivity (If there were a difference in conductivity, it could be possible that the electronic tongue measured this and nothing else. The result would still be valid but render the method superfluous, as there are much simpler means to measure conductivity).

Choice of Electrodes

The tongue used in this project had one reference electrode and four working electrodes: gold, iridium, platinum, and rhodium. Gold is known to be sensitive to chloride ions and iridium is known to deteriorate easily in general, hence both were excluded from the beginning.

However, they both do contribute with information, and a more careful selection of voltage function would still render these materials useful, and are therefore not excluded from the invention as claimed.

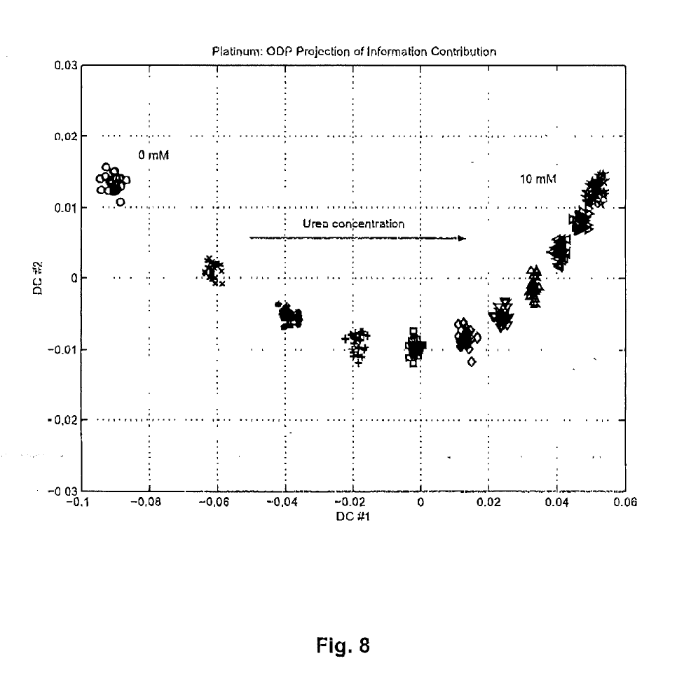

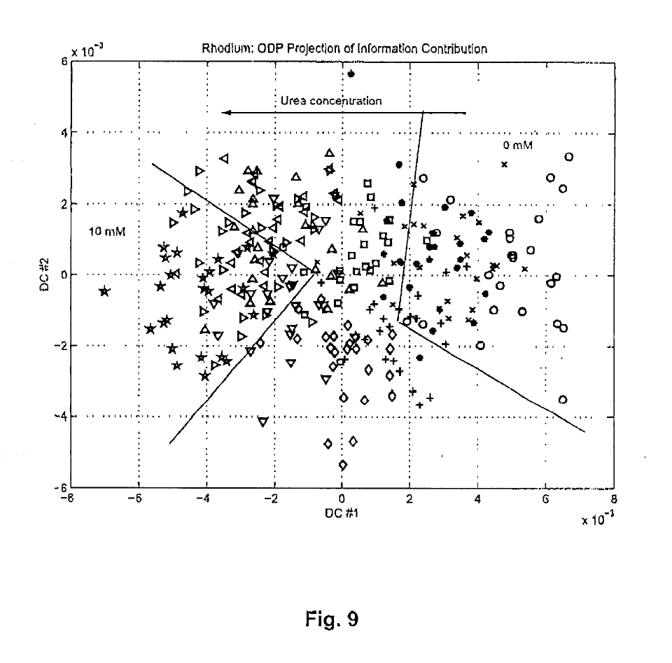

FIGS. 8 and 9 show ODP score plots for platinum and rhodium, respectively, for one measurement series of 0—10 mM urea in dialytic liquid. The large difference clearly shows platinum to be superior to rhodium. Because of this, the rhodium electrode was excluded from all subsequent measurements. However, it cannot be ruled out that rhodium and the other electrodes may be useful if one employs different step functions. As already indicated, other metals than the ones mentioned here may also be useful.

The Measurement Procedure

In all measurements regarding different concentrations the order of measurement on the respective concentrations was randomized. This was to make sure that the results were not caused by tongue drift alone. To simplify the data processing, a standard measurement series was created. The concentrations 0, 1, 2, . . . , 10 mM of urea were included five times. The standard measurement series used in these experiments was:

Series 1: 3 0 7 2 9 5 8 1 6 4 10 (mM)

Series 2: 6 3 0 10 1 9 5 4 2 8 7 (mM)

Series 3: 7 1 9 0 6 4 8 10 5 2 3 (mM)

Series 4: 10 3 6 9 0 2 4 5 1 7 8 (mM)

Series 5: 4 1 7 10 5 3 0 2 8 9 6 (mM)

The concentrations in the series are to be read row-wise as any text. Each number in the list above corresponds to one measurement (i.e. five cycles) of that concentration. No pauses were made between the rows.

### EXAMPLES

### Electrode Stability

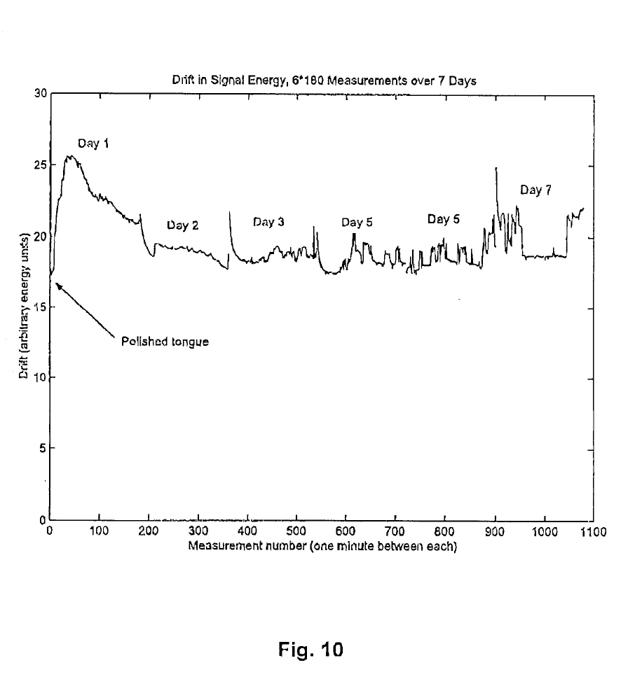

Signal energy was used as a measure to monitor the electrode condition over a series of measurements. Each measurement corresponds to a value Eₖ, where E is the energy and k is the number of the measurement, defined as:

$${E}_{k} = {\sum }_{i = 1}^{n} {( {A}_{key\_no \_i} )}^{2}$$

where A_{key} signifies the amplitude of key number i and n is the total number of keys in the step function. The tongue was polished before the first measurement. 1100 measurements were made on 5 mM urea in dialytic liquid over six different occasions during one week. One minute separated each measurement and the liquid was renewed between each measurement. The variation in signal energy as a function of time is shown in FIG. 10. Except for the obvious noise, three things are interesting:

1) A large transient drift during the first 200 measurements. This is probably due to an oxidizing process that reaches equilibrium.

2) A shorter transient is observed at the beginning of each subsequent measurement series, taking approximately 20 measurements to complete. This may be considered as the stabilization time for the tongue to adjust to the dialytic liquid (possibly because it is stored in de-ionized water when not in use).

3) The average signal energy for the measurements tends to stabilize around a constant value. This indicates that the electrode surface is rather stable in dialytic liquid.

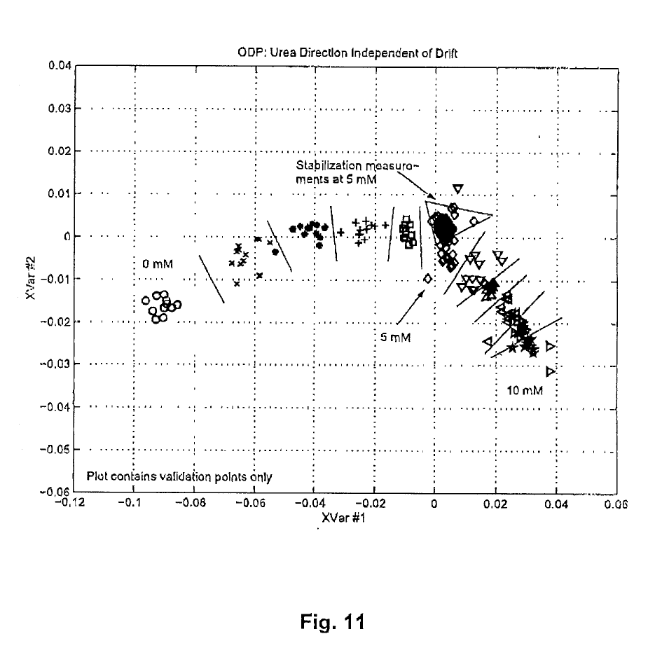

Is there a constant ‘urea direction’ in measurement space? In part this is answered by plotting the measurement points from the stabilization experiment above in the same plot as a normal concentration measurement series from the week before. The ODP plot in FIG. 11 shows that there is indeed a constant urea direction, at least over a period of two weeks with a polishing of the tongue in between. Note that even the first day of the stabilization measurements is included as well. This leads to two conclusions:

ODP is outstanding in neglecting drift directions. The part of the signal that signifies urea content is superimposed upon a ‘base signal’, the latter of which is intimately coupled to the electrode surface condition.

Predictability within a Measurement Series

The purpose of this experiment was to see how much information about the urea content in dialytic liquid is actually provided by the electronic tongue with the parameter setup as defined above. At the same time, the difference between PLS and ODP should be evaluated. The tongue was not polished before the measurements started, so it could probably be considered as already stabilized.

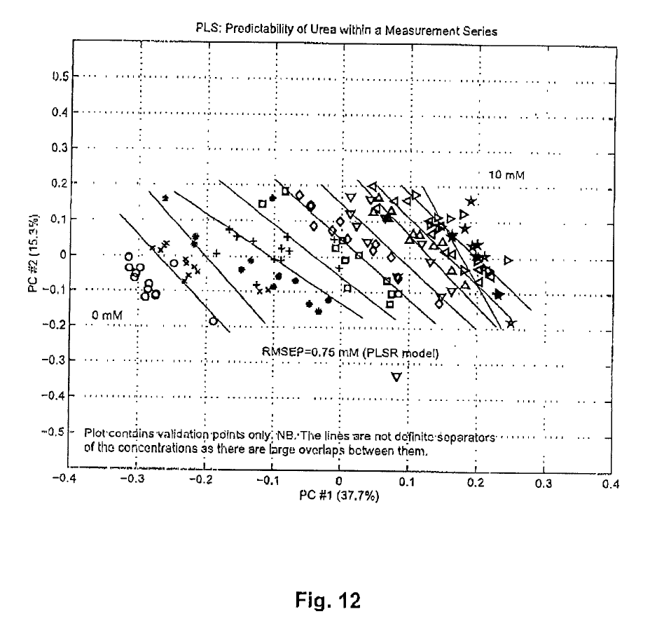

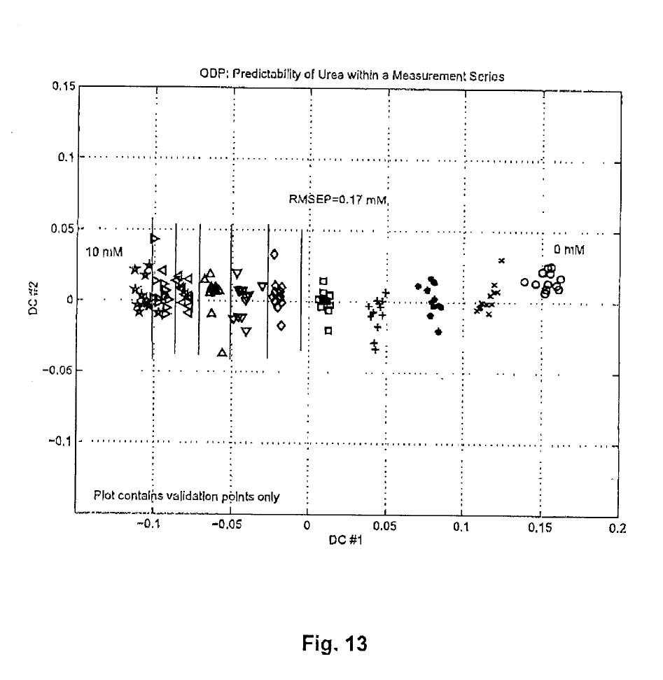

Regression models were built for both the PLS and ODP projections. FIG. 12 shows a PLS score plot of the validation data when 50% of the data set was used for training and the other half for validation. The RMSEP value for these predictions was 0.75 mM, i.e. a relative error of 7.5% FIG. 13 shows the corresponding ODP score plot, which in turn gives an RMSEP of 0.17 mM or 1.7%. This result from the ODP/CRA predictions is outstanding but should not be generalized as the predictions are made within one measurement series.

Predictions within a measurement series give a good hint of what information is actually existent in the tongue data but tells little about how useful the technology would be in a real application outside the laboratory. The main reason for this is that long-term drift is not considered. A first step towards an evaluation of long-term predictive power of the technology is, for example, to make a number of measurement series and use some of them to build a regression model and predict the rest. Hence the next experiment.

Predictability between Measurement Series

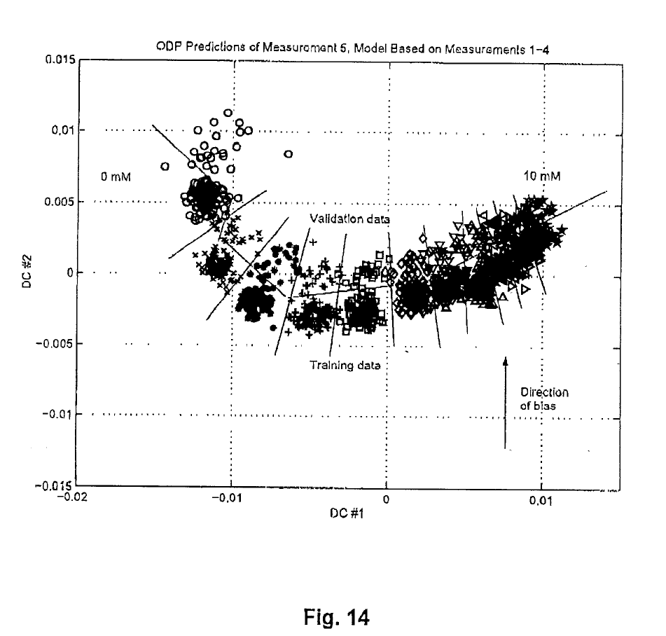

Five standard measurement series were made over a few days. The purpose was mainly to test the difference between PLS and ODP for a situation that involves some long-term drift. The tongue was polished before the first series started. No stabilization time was allowed for the tongue and all data was included in the analysis, i.e. a worst possible scenario for the algorithms given the experimental setup. The ODP score plot in FIG. 14 shows both training and validation data for the predictions of measurement series 5 from a model based on measurement series 1-4. Plotting both training and validation data is interesting in this case when predicting measurements from a set not included in the building of the model; As is seen in the figure there is a direction of bias (a systematic difference between training and validation data), probably because the model was not built on data containing this drift direction.

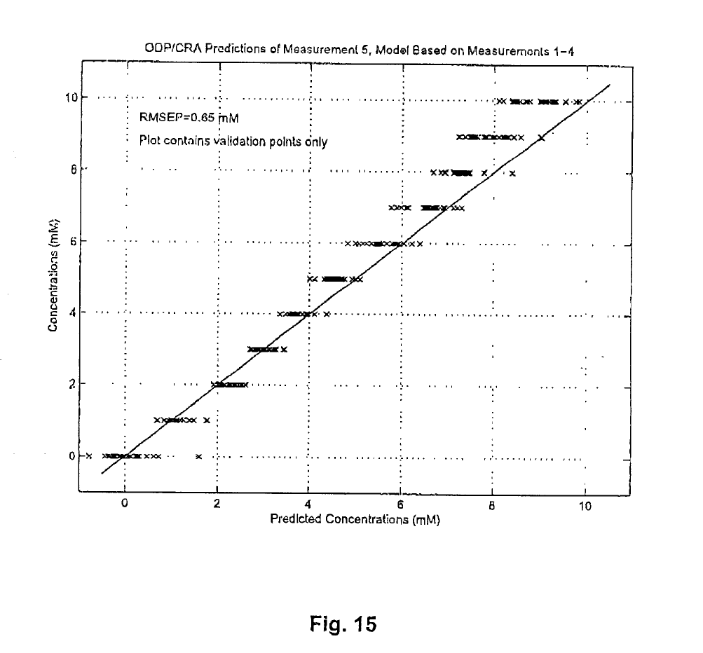

The RMSEP was 0.96 mM for PLSR and 0.65 mM for ODP/CRA. As there is a bias in the model, also seen in the predicted vs measured plot in FIG. 15 at the higher concentrations, additional improvements are to be expected if higher-order terms can be successfully included in the model. However, such an effort would probably prove futile compared to including more data in the model and should in any case be made after such an inclusion.

Calibration

Need for Calibration

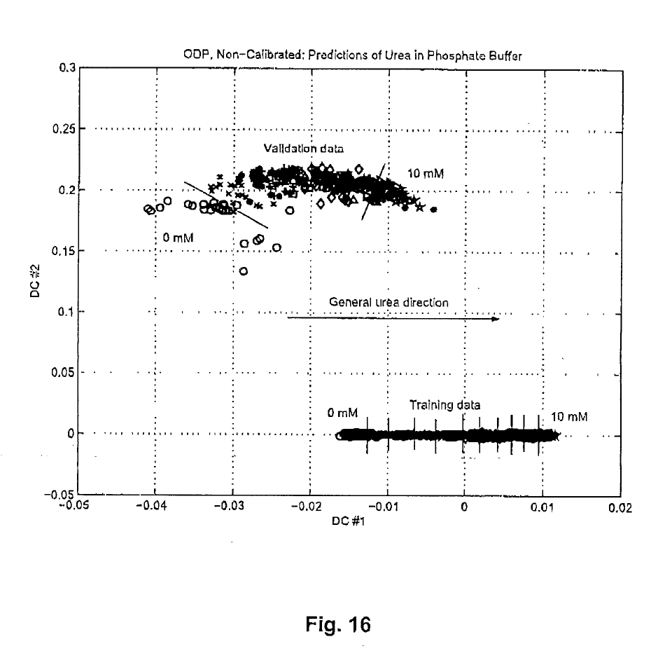

FIG. 16 shows an ODP score plot of urea measurements in both dialytic liquid and phosphate buffer. The data from the dialytic liquid has been used for training and the data from the phosphate buffer for validation. Since the phosphate buffer that was used in this experiment was very different from the dialytic liquid, for example by having 50% higher conductivity and phosphate rather than carbonate as a buffer, it is natural that the two separate in measurement space. What is interesting, however, is that the urea direction seems to be constant not only over time, as was shown in Section Stability, but also for two chemically different liquids. This positive result made plausible that a rather simple calibration algorithm should be able to compensate for differences in liquids.

Calibration Algorithm and Results

A first tentative calibration algorithm was based on the idea that the urea content information is superimposed upon a ‘base signal’, as has already been discussed in Section Stability. Thus the base signal is calculated whenever a new measurement starts—though allowing for some initial stabilization—and then subtracted from all the subsequent measurements. In linear algebra terms, this is a linear translation and should, theoretically, ‘bring down’ the urea variation around the origin in the multidimensional measurement space. In practice, the base signal is estimated by taking a row vector average over a certain number of measurements.

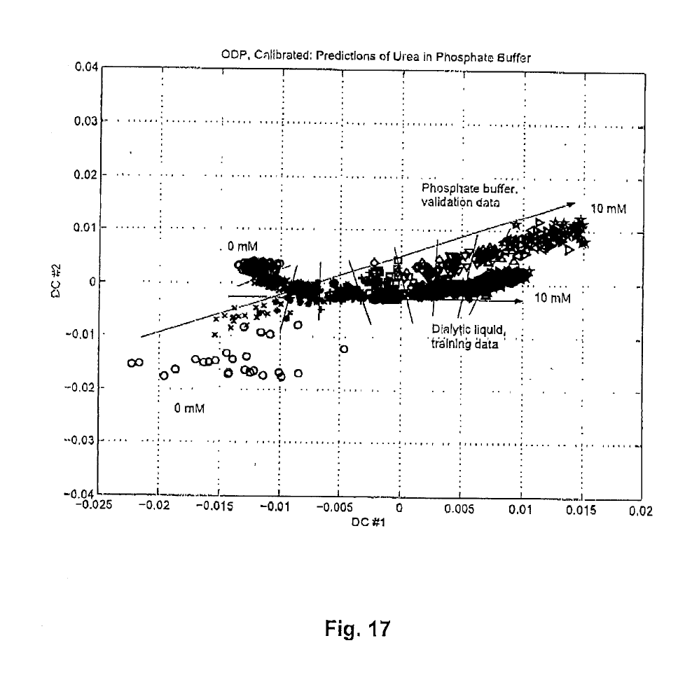

FIG. 17 shows the same thing as FIG. 16 with the only difference that the data has been calibrated according to the algorithm described above. The match is not perfect but satisfactory, especially in the interval 1-6 mM.

Regression models were made for both the PLS and the ODP plots (of which the PLS plots are not included in the report), resulting in the following RMSEP values:

Non-calibrated data: PLSR, RMSEP=2.31 mM (23.1% relative error)

Non-calibrated data: CRA, RMSEP=5.23 mM (52.3% relative error)

Calibrated data: PLSR, RMSEP=1.48 mM (14.8% relative error)

Calibrated data: CRA, RMSEP=1.32 mM (13.2% relative error)

This result clearly shows the benefit of a calibration algorithm whenever the liquids might change chemical constitution. Tests were also made to evaluate the efficacy of the calibration algorithm in compensating regular tongue drift (as opposed to changes in the liquid), with the somewhat surprising result that it didn't affect the RMSEP values by more than a couple of percent. This is probably because drift directions were already taken into account, i.e. neglected, in the model-building. A hardware instability has been observed. By calculating the mean value of three or so cycles before the translation discussed above the instability can probably be reduced.

By virtue of the fact that the present system is an on-line, real-time monitoring system, it is very well adapted for automatic control of the status of a treatment, such as dialysis. Thus, in one embodiment of the system there is provided for a continuous output of concentration values of the analyte under observation, e.g. urea, onto a display, in the form of a graph that gives a visual and readily comprehensible indication of the progress of the treatment. Thereby the physician or nursing or operating staff by graphically monitoring the measurements in real-time, can easily determine when treatment has reached a point where it can be stopped.

Another way of signaling when the treatment has been completed is in a further embodiment the provision of an indicator lamp shining red as long as a predetermined level of the analyte has not been reached, and as soon as the set value is reached, it can turn green, indicating complete treatment. This being only exemplifying, the skilled man would be able to devise alternative representations of the measurement results, and such representations are not excluded by the above examples.

1. (USA) A method of monitoring a physiological condition of a patient by measuring at least one indicator component concentration in a liquid, comprising:
providing a liquid containing at least one indicator component, the concentration of which in said liquid being indicative of said physiological condition;
bringing said liquid into contact with a voltammetric electronic tongue, having at least one working electrode consisting essentially of a metal or alloy selected from members of any of the groups 6-12 of the periodic table, preferably groups 9-1;
applying a predefined potential pulse program to said at least one working electrode and a counter electrode;
recording current response data caused by said potential pulse program;
performing a mathematical analysis of recorded current response data according to a model based on multivariate analysis to provide a result.

2. The method of claim 1, wherein said liquid is selected from the group consisting of whole blood, blood plasma, dialysis liquid, urine, intestinal liquids, gastric liquid.

3. The method of claim 1, wherein said liquid is dialysis liquid and the indicator component(s) is selected from one or more of urea, β2-microkinase, albumin, cholesterol, PTH (Parathyroid Hormone), K+, Ca2+, Creatinine.

4. The method of claim 1, wherein said at least one electrode is one or more of Pt, Au, Rh, Ir or alloys thereof.

5. The method of claim 1, wherein the potential pulse program comprises potential pulses having a duration of less than 700 ms, preferably less than 100 ms, most preferably less than 50 ms, and suitably 25 ms or less.

6. The method of claim 5, wherein the pulses of said potential pulse program exhibit a stepped amplitude sequence, and wherein said pulses extend from a positive to a negative potential or vise versa during each period in the pulse train.

7. The method of claim 6, wherein said pulse program is specific to each individual electrode.

8. The method of claim 7, wherein one electrode is Pt and the initial pulse step is from −2V to +2V, and thereafter incrementally decreases towards zero, and optionally after a cross-over at zero V, the steps change polarity such that the pulses extend from negative to positive until a maximum of −2V and +2V respectively, is reached, and then back to zero.

9. A system for monitoring a physiological condition of a patient by measuring at least one indicator component concentration in a liquid, comprising:
a voltammetric sensor unit comprising at least one electrode made of a material selected from any of the groups 6-12 of the periodic table, preferably groups 9-11;
a counter electrode;
a potentiostat having a programmable pulse generator;
a processing unit for the mathematical processing of voltammetric data using a model based on multivariate analysis.

10. The system of claim 9, further comprising a reference electrode.

11. The system of claim 9, wherein said liquid is selected from the group consisting of whole blood, blood plasma, dialysis liquid, urine, intestinal liquids, gastric liquid.

12. The system of claim 11, wherein said liquid is a dialysis liquid and wherein said sensor unit is arranged in a dialysis liquid flow path after a filter unit of a dialysis apparatus.

13. The system of claim 12, comprising a further sensor unit, arranged before said filter unit.

14. The system of claim 11, wherein said liquid is blood derived from a patient and wherein said sensor unit is arranged to measure the desired component in a sample of said blood.

15. The system of claim 14, wherein said blood is sampled by continuously withdrawing blood from a patient, and wherein said sensor unit is arranged in the flow path of the blood.

16. The system of claim 9, comprising a display unit for graphically monitoring the measurements//in real-time, e.g. as a graph.

17. The system of claim 9, further comprising a device presenting a visual and/or audio signal representative of when a predefined result has been detected.

18. A method of detecting the presence and/or the concentration of an analyte in a liquid, comprising:
providing a liquid containing at least one analyte selected from the group consisting of urea, heparin, β2-microkinase, albumin, cholesterol, PTH (Parathyroid Hormone), K⁺, Ca²⁺, Creatinine;
bringing said liquid into contact with a voltammetric electronic tongue, having at least one working electrode consisting essentially of a metal or alloy selected from members of any of the groups 6-12 of the periodic table, preferably groups 9-11;
applying a predefined potential pulse program to said at least one working electrode and a counter electrode;
recording current response data caused by said potential pulse program;
performing a mathematical analysis of recorded current response data according to a model based on multivariate analysis to provide a result.

19. A method as claimed in claim 18, wherein said liquid is selected from a member of the group consisting of urine, intestinal liquids, gastric liquids, lymphatic liquids.
